(19) United States
(12) Patent Application Publication
(10) Pub. No.: US 2024/0040558 A1
(43) Pub. Date: Feb. 1, 2024

(54) LAYER CONTROL BASED ON RADIO FREQUENCY HARDWARE RESOURCE CONSTRAINTS

(71) Applicant: QUALCOMM Incorporated, San Diego, CA (US)

(72) Inventors: Syam Pavan VADAPALLI, Visakhapatnam (IN); Ankammarao RAVUVARI, Hyderabad (IN); Roop Sagar INAKOLLU, Nellore (IN)

(21) Appl. No.: 17/815,906

(22) Filed: Jul. 28, 2022

(51) Int. Cl. H04W 72/12

(52) U.S. Cl. CPC H04W 72/1205

(57) ABSTRACT

This disclosure provides systems, methods and apparatus, including computer programs encoded on computer storage media, for a base station and a user equipment (UE) to communicate using a number of layers that is preferred by the UE. The UE and the network may communicate using radio frequency (RF) resources according to a number of layers corresponding to a capability of the UE. The UE may detect a constraint on the RF resources. The UE may transmit information of a preferred number of layers that is preferred by the UE to the network in response to the detecting. The base station may schedule the UE to communicate based on the preferred number of layers that is preferred by the UE.

### TECHNICAL FIELD

The present disclosure relates to wireless communications including layer control based on radio frequency hardware resource constraints.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communication for a user equipment (UE), including: communicating, with a network, using radio frequency (RF) resources according to a number of layers corresponding to a capability of the UE; detecting a constraint on the RF resources; and transmitting information of a preferred number of layers that is preferred by the UE to the network in response to the detecting.

In some aspects, the techniques described herein relate to a method, wherein the UE is a dual subscriber identification module (SIM) dual active (DSDA) user equipment.

In some aspects, the techniques described herein relate to a method, wherein detecting the constraint on the RF resources is based on activity for a second subscription while the UE is communicating with the network for a first subscription.

In some aspects, the techniques described herein relate to a method, wherein the UE communicates with the network for the first subscription on a first band and communicates with a second network for the second subscription on the first band.

In some aspects, the techniques described herein relate to a method, wherein detecting the constraint on the RF resources is based on a low power condition.

In some aspects, the techniques described herein relate to a method, wherein the RF resources are transmit chain components or receive chain components.

In some aspects, the techniques described herein relate to a method, wherein transmitting the information of the number of layers that is preferred by the UE includes transmitting a media access control (MAC) control element (CE) indicating the preferred number of layers.

In some aspects, the techniques described herein relate to a method, wherein transmitting the information of the number of layers that is preferred by the UE includes transmitting an uplink control information (UCI) element indicating the preferred number of layers.

In some aspects, the techniques described herein relate to a method, wherein the UCI further includes a rank indicator or layer indicator separate from the number of layers that is preferred by the UE.

In some aspects, the techniques described herein relate to a method, further including transmitting a capability message indicating the number of layers corresponding to the UE capability.

The present disclosure also provides an apparatus (e.g., a UE) including means for performing the above method, and a non-transitory computer-readable medium storing computer-executable instructions for performing the above method.

In some aspects, the techniques described herein relate to a method of wireless communication for a base station, including: communicating, with a user equipment (UE), using a number of layers corresponding to a capability of the UE; receiving, from the UE, information of a preferred number of layers that is preferred by the UE; and scheduling the UE to communicate based on the number of layers that is preferred by the UE.

In some aspects, the techniques described herein relate to a method, wherein the UE is a dual subscriber identification module (SIM) dual active (DSDA) user equipment.

In some aspects, the techniques described herein relate to a method, wherein receiving the information of the number of layers that is preferred by the UE includes receiving a media access control-control element (MAC-CE) or an uplink control information (UCI) element indicating the number of layers.

In some aspects, the techniques described herein relate to a method, wherein the UCI further includes a rank indicator or layer indicator separate from the number of layers that is preferred by the UE.

In some aspects, the techniques described herein relate to a method, further including receiving a capability message indicating the number of layers corresponding to the UE capability.

The present disclosure also provides an apparatus (e.g., a BS) including means for performing the above method, and a non-transitory computer-readable medium storing computer-executable instructions for performing the above method.

In some aspects, the techniques described herein relate to an apparatus of a user equipment (UE), including: a memory storing computer-executable instructions; and at least one processor coupled to the memory and configured to execute the computer-executable instructions to: communicate, with a network, using radio frequency (RF) resources according to a number of layers corresponding to a capability of the UE; detect a constraint on the RF resources; and transmit information of a preferred number of layers that is preferred by the UE to the network in response to the detecting.

In some aspects, the techniques described herein relate to an apparatus, wherein the UE is a dual subscriber identification module (SIM) dual active (DSDA) user equipment.

In some aspects, the techniques described herein relate to an apparatus, wherein the at least one processor is configured to detect the constraint on the RF resources based on activity for a second subscription while the UE is communicating with the network for a first subscription.

In some aspects, the techniques described herein relate to an apparatus, wherein the UE communicates with the network for the first subscription on a first band and communicates with a second network for the second subscription on the first band.

In some aspects, the techniques described herein relate to an apparatus, wherein the at least one processor is configured to detect the constraint on the RF resources based on a low power condition.

In some aspects, the techniques described herein relate to an apparatus, wherein the RF resources are transmit chain components or receive chain components.

In some aspects, the techniques described herein relate to an apparatus, wherein to transmit the information of the number of layers that is preferred by the UE wherein the at least one processor is configured to transmit a media access control (MAC) control element (CE) indicating the preferred number of layers.

In some aspects, the techniques described herein relate to an apparatus, wherein to transmit the information of the number of layers that is preferred by the UE, the at least one processor is configured to transmit an uplink control information (UCI) element indicating the preferred number of layers.

In some aspects, the techniques described herein relate to an apparatus, wherein the UCI further includes a rank indicator or layer indicator separate from the number of layers that is preferred by the UE.

In some aspects, the techniques described herein relate to an apparatus, wherein the at least one processor is configured to transmit a capability message indicating the number of layers corresponding to the UE capability.

In some aspects, the techniques described herein relate to an apparatus of wireless communication for a base station, including: a memory storing computer-executable instructions; and at least one processor coupled to the memory and configured to execute the computer-executable instructions to: communicate, with a user equipment (UE), using a number of layers corresponding to a capability of the UE; receive, from the UE, information of a preferred number of layers that is preferred by the UE; and schedule the UE to communicate based on the number of layers that is preferred by the UE.

In some aspects, the techniques described herein relate to an apparatus, wherein the UE is a dual subscriber identification module (SIM) dual active (DSDA) user equipment.

In some aspects, the techniques described herein relate to an apparatus, wherein to receive the information of the number of layers that is preferred by the UE, the at least one processor is configured to receive a media access control-control element (MAC-CE) or an uplink control information (UCI) element indicating the number of layers.

In some aspects, the techniques described herein relate to an apparatus, wherein the UCI further includes a rank indicator or layer indicator separate from the number of layers that is preferred by the UE.

In some aspects, the techniques described herein relate to an apparatus, wherein the at least one processor is configured to receive a capability message indicating the number of layers corresponding to the UE capability.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 shows a diagram illustrating an example disaggregated base station architecture.

FIG. 5 is a diagram illustrating an example of radio frequency (RF) resources for a UE.

FIG. 6 is a diagram of an example scenario with an RF resource constraint in a dual subscriber identification module-dual active (DSDA) UE.

FIG. 7 is a message diagram illustrating example messages between a base station and a UE.

FIG. 8 is a conceptual data flow diagram illustrating the data flow between different means/components in an example UE.

FIG. 9 is a conceptual data flow diagram illustrating the data flow between different means/components in an example base station.

FIG. 10 is a flowchart of an example method for a UE to indicate a preferred number of layers based on a RF resource constraint.

FIG. 11 is a flowchart of an example method for a base station to schedule a UE to communicate according to a preferred number of layers.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (JOT) network, such as a system utilizing 3G, 4G or 5G, or further implementations thereof, technology. In wireless communications, multiple-input multiple-output (MIMO) may be used to improve communications. For example, MIMO may allow for transmissions using multiple layers. A user equipment (UE) may indicate MIMO capabilities including a number of layers that the UE may transmit and receive. In some cases, the radiofrequency (RF) hardware of the UE may be subject to a constraint that limits the number of layers. For example, a dual-subscriber identification module (DS) dual-active (DSDA) UE may concurrently communicate with two networks for two subscriptions. Communications for the second subscription may utilize RF resources such as antennas, transmit chains, or receive chains that are supporting multiple layer communications of the first network. For instance, when a new session is started for the second subscription, a receive chain being used by the first subscription may be reassigned to the second subscription. This constraint on the RF resources may prevent the UE from receiving one or more layers.

Currently, there may be no effective mechanism for the UE to communicate a limit on the number of layers to a network. The UE may provide uplink control information (UCI) including a channel quality indicator (CQI), rank indicator (RI), and precoding matrix indicator (PMI). While these parameters provide information about channel conditions, these parameters do not indicate a status or constraint on RF resources. For example, although RI indicates an effectiveness of MIMO techniques based on channel conditions, the RI may not be effective for signaling a constraint on RF resources. While a high RI may be used by the network to select a higher number of layers, a constraint on RF resources may not lower the RI. For instance, even if a receive chain becomes unavailable, the channel conditions may remain the same and the UE may report the same RI. Even if the UE artificially lowers the reported RI, the network may perform its own measurements of channel conditions to select the number of layers. For example, the network may assign a number of layers that the UE is unable to transmit or receive.

In some cases, a UE with RF resource constraints may experience negative effects in scheduling. For instance, if a base station assigns a number of layers that the UE is unable to transmit or receive, the UE may repeatedly fail to transmit the correct number of layers or may fail to decode the transmitted layers. The network may classify such performance as erroneous behavior and may impose scheduling limits on the UE, which may persist even when the RF resource constraint is lifted.

In an aspect, the present disclosure provides for techniques for the UE to indicate a limit on a number of layers. For example, the UE may initially communicate with a network using RF resources according to a number of layers corresponding to a capability of the UE. For instance, the network may schedule the UE with a number of layers based on the reported capability of the UE. The UE may detect a limitation of the RF resources. For example, the UE may determine that RF resources are used to communicate with a second network for a second subscription. The UE may transmit information of a number of layers that is preferred by the UE to the network in response to the detecting. For example, the UE may transmit a media access control (MAC) control element (CE) or an uplink control information including the information of the number of layers that is preferred by the UE.

Particular implementations of the subject matter described in this disclosure can be implemented to realize one or more of the following potential advantages. The base station may schedule the UE to communicate using the preferred number of layers, thereby more efficiently utilizing time and frequency resources. For instance, fewer resources may be utilized for retransmissions. In some implementations, the UE may transmit the information of the preferred number of layers using a MAC-CE or UCI, which may allow dynamic adaptation of the preferred number of layers.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

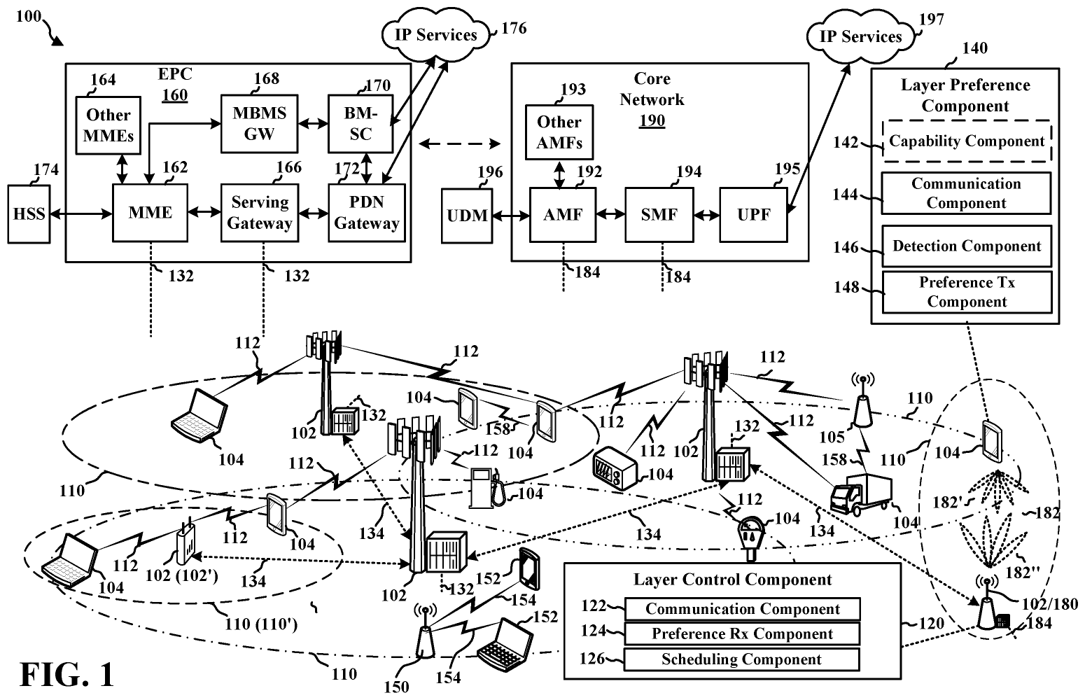

FIG. 1 is a diagram illustrating an example of a wireless communications system and an access network 100. The wireless communications system (also referred to as a wireless wide area network (WWAN)) includes base stations 102, UEs 104, relay devices 105, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some implementations, one or more of the receiving devices such as UEs 104 may include a layer preference component 140 configured to indicate a number of layers preferred by the UE based on an RF resource constraint. The layer preference component 140 may optionally include a capability component 142 configured to transmit a capability message indicating the number of layers corresponding to a UE capability (e.g., based on hardware RF resources of the UE). The layer preference component 140 may include a communication component 144 configured to communicate, with a network, using RF resources according to a number of layers corresponding to a capability of the UE. The layer preference component 140 may include a detection component 146 configured to detect a limitation of the RF resources. The layer preference component 140 may include a preference transmit (Tx) component 148 configured to transmit information of a number of layers that is preferred by the UE to the network in response to the detecting.

In some implementations, one or more of the base stations 102 may include a layer control component 120 configured to schedule communications using a number of layers based on a UE preference. The layer control component 120 may include a communication component 122 configured to communicate, with a UE, using a number of layers corresponding to a capability of the UE. The layer control component 120 may include a preference receive (Rx) component 124 configured to receive, from the UE, information of a number of layers that is preferred by the UE. The layer control component 120 may include a scheduling component 126 configured to schedule the UE to communicate based on the number of layers that is preferred by the UE.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

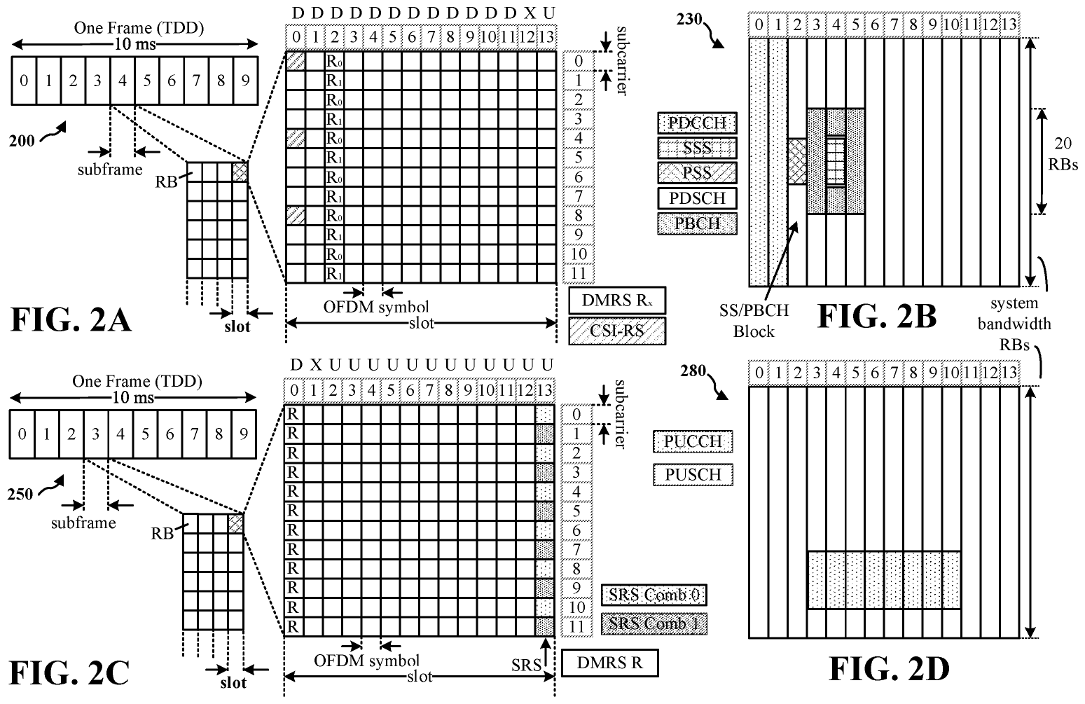

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used.

The UE may transmit sounding reference signals (SRS). An SRS resource set configuration may define resources for SRS transmission. For example, as illustrated, an SRS configuration may specify that SRS may be transmitted in the last symbol of a subframe. The SRS may have a comb structure, and a UE may transmit SRS on one comb for each SRS port. The SRS may be used by a base station for channel quality estimation to enable frequency-dependent scheduling on the UL. The SRS may also be used for channel estimation to select a precoder for downlink MIMO.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

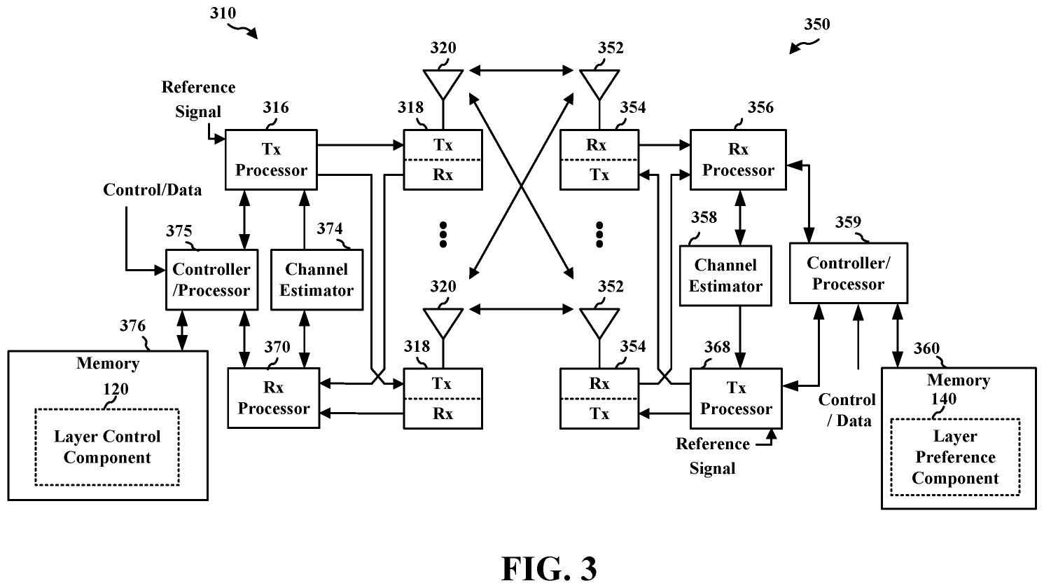

FIG. 3 is a diagram of an example of a base station 310 and a UE 350 in an access network. The UE 350 may be an example of a receiving device. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIB s), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TB s), demultiplexing of MAC SDUs from TB s, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the Tx processor 368, the Rx processor 356, and the controller/processor 359 may be configured to perform aspects in connection with the layer preference component 140 of FIG. 1. For example, the memory 360 may include executable instructions defining the layer preference component 140. The Tx processor 368, the Rx processor 356, and/or the controller/processor 359 may be configured to execute the layer preference component 140.

At least one of the Tx processor 316, the Rx processor 370, and the controller/processor 375 may be configured to perform aspects in connection with the layer control component 120 of FIG. 1. For example, the memory 376 may include executable instructions defining the layer control component 120. The Tx processor 316, the Rx processor 370, and/or the controller/processor 375 may be configured to execute the layer control component 120.

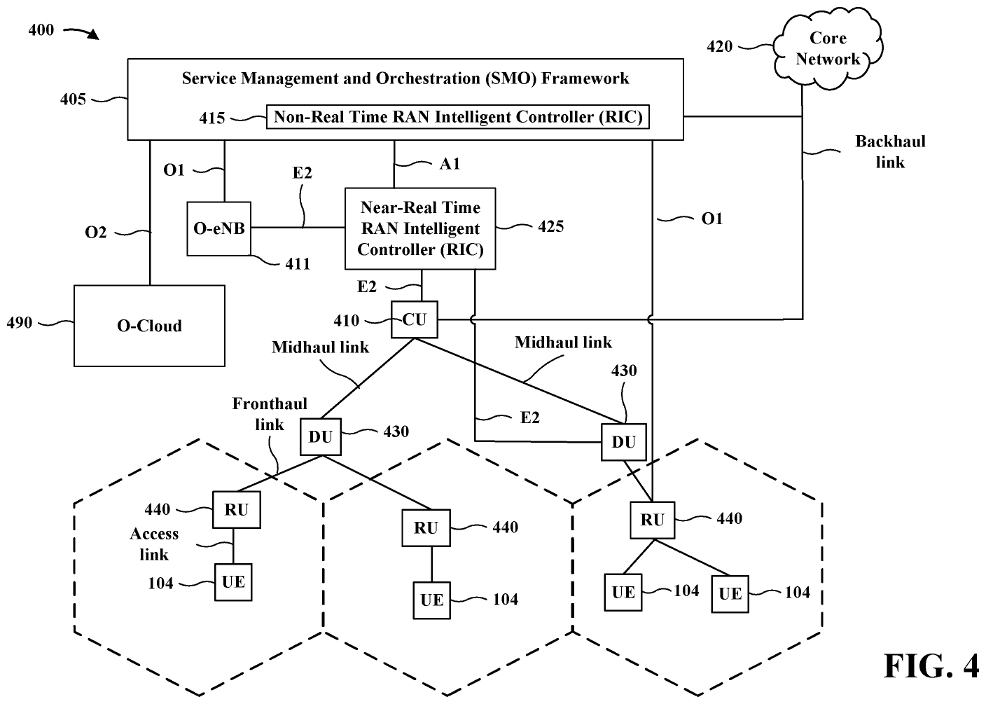

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3 rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

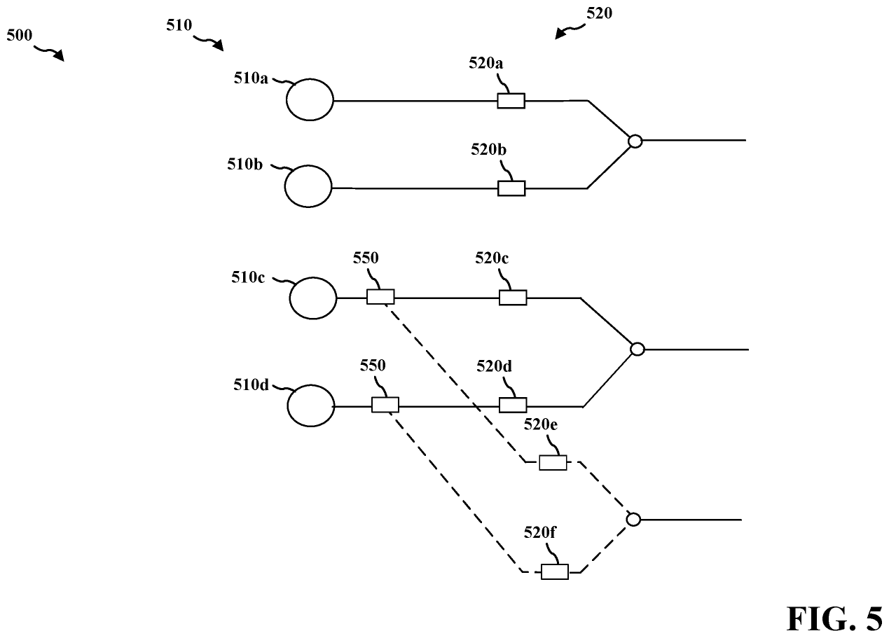

FIG. 5 is a diagram illustrating an example of RF resources 500 for a UE. The RF resources 500 may be located in an RF front end. The RF resources 500 may include antenna ports 510 (e.g., antenna ports 510a, 510b, 510c, 510d), each of which may be connected to a respective antenna or antenna element. The RF resource 500 may include transmit chain or receive chain component 520 (e.g., components 520a, 520b, 520c, 520d). For example, the transmit chain or receive chain components 520 may include one or more low-noise amplifiers (LNAs), one or more switches, one or more power amplifiers (PAs), and one or more filters for transmitting and receiving RF signals.

Typically, each transmit or receive chain may process RF signals within a frequency band and each antenna port may be assigned to the frequency band. In a DSDA UE, the subscriptions may be for networks that communicate in the same band or in different bands. For example, a first subscription may be for a first network operating in a first band and the second subscription may be for a second network operating in the first band or in a second band. When the first network and the second network operate on the same band, the UE may need to assign separate antenna ports to each network or subscription. Accordingly, if the UE indicates a capability based on the number of antenna ports 510, and then one or more of the antenna ports 510 is assigned to the second network, the UE may be unable to process as many layers for the first network as indicated by the capability.

In some implementations, one or more transmit or receive chains may include a diplexor or segregator 550 configured to diplex or separate signals from different bands. For instance, when the first network and the second network operate different bands, it may be possible to diplex uplink signals for transmission via the same antenna port, or to separate downlink signals received on the same antenna port. In such implementations, the UE may communicate with the first network using the number of layers corresponding to an indicated UE capability while also communicating on the second band with the second network. Such functionality, however, may utilize additional transmit or receive chain components 520 (e.g., 520e and 520f). Such additional transmit or receive chain components 520 may be available in some DSDA UEs, but may add cost and/or complexity to the UE design. Further, additional transmit or receive chain components 520 may support limited combinations of bands.

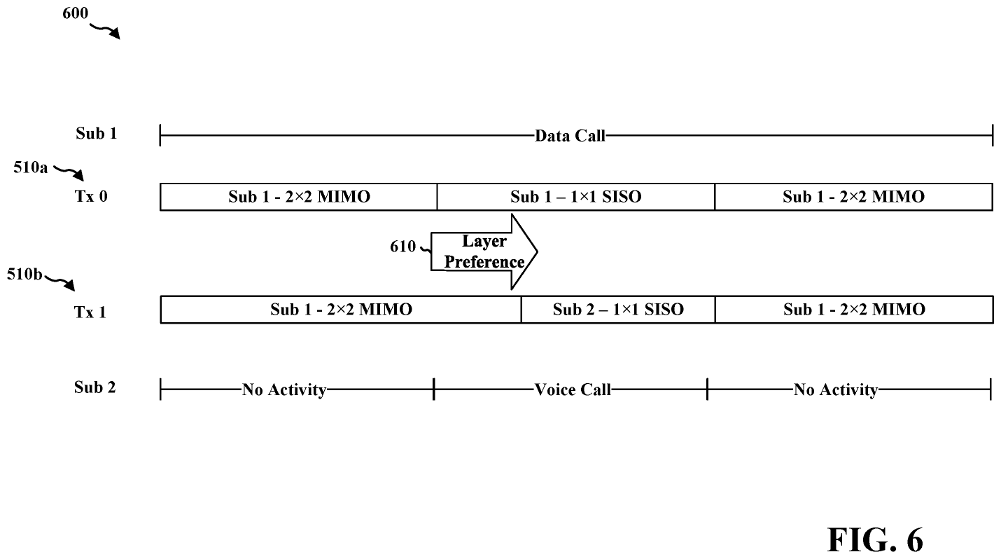

FIG. 6 is a diagram 600 of an example scenario with an RF resource constraint in a DSDA UE. The DSDA UE may include two transmit chains (e.g., Tx0 and Tx1) associated with antenna ports 510a and 510b, for example. The DSDA UE may be on a data call with a first network for a first subscription (Sub 1). The DSDA UE may initially use both Tx0 and Tx1 for 2×2 MIMO for UL transmissions. The DSDA UE may receive a voice call for a second subscription (Sub 2) on a second network. The DSDA UE may reassign Tx1 to Sub 2. The UE may be limited to 1×1 SISO for UL transmissions for both Sub 1 and Sub 2. The first network, however, may be unaware of this constraint on the UL RF resources. The first network may continue to schedule the DSDA UE for 2×2 MIMO, which may result in failed transmissions (e.g., the first network not decoding a second layer that was not transmitted).

In an aspect, the DSDA UE may transmit a layer preference message 610 indicating information of a number of layers that is preferred by the UE. For example, the DSDA UE may transmit the layer preference message 610 in response to detecting a constraint on the RF resources due to the voice call on Sub 2. The first network may schedule the DSDA UE based on the layer preference message 610. For example, the network may schedule the DSDA UE to use 1×1 SISO for UL transmissions, which the DSDA UE can transmit using Tx0.

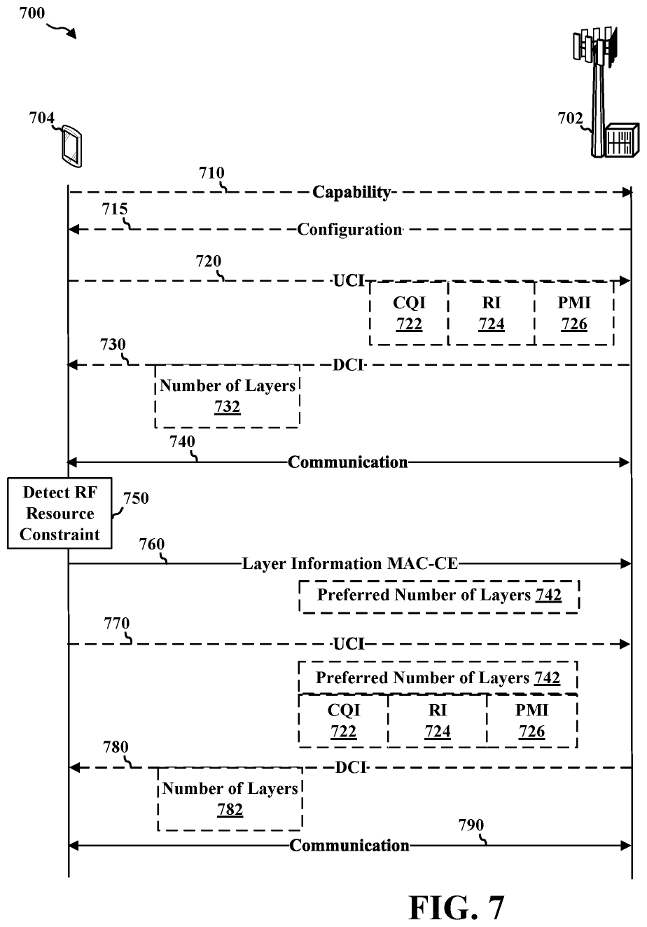

FIG. 7 is a message diagram 700 illustrating example messages between a base station 702 and a UE 704. The UE 704 may be an example of a UE 104 including the layer preference component 140. The base station 702 may be an example of a base station 102 including the layer control component 120.

In some implementations, the UE 704 may optionally transmit a capability message 710 to the base station 702. For example, the capability message 710 may be a RRC message. The capability message 710 may indicate, for example, that the UE 704 is capable of a maximum rank for uplink communications and a maximum ranks for downlink communication. For instance, the UE 704 may indicate DL MIMO 4×4 & UL MIMO 2×2.

In some implementations, the base station 702 may optionally transmit a configuration 715. The configuration 715 may indicate one or more configuration parameters related to a number of layers. For example, the configuration 715 may indicate a DMRS Configuration Type and max Length.

In some implementations, the UE 704 may optionally transmit a UCI 720. The UCI 720 may indicate channel quality and MIMO characteristics. For example, the UCI 720 may include one or more of a CQI 722, RI 724, or PMI 726.

In some implementations, the base station 702 may transmit a downlink control information (DCI) 730 to schedule an uplink or downlink transmission. The DCI 730 may include a field indicating a number of layers 732. In some implementations, the UE 704 may determine a number of layers based on the DMRS Configuration Type, max Length, and number of layers 732.

The base station 702 and the UE 704 may transmit and receive communications 740 based on a number of layers corresponding to the capability of the UE. For example, the base station 702 may determine the parameters of configuration 715 and the number of layers 732.

At block 750, the UE 704 may detect an RF resource constraint. For example, the RF resource constraint may include any condition that reduces a number of available RF resources below a capability indicated by the UE 104. For example, as discussed above, an active call for a second subscription of a DSDA UE may be assigned RF resources that become unavailable for a first subscription. For instance, if the UE 704 transmitted capability message 710 indicating a capability of 4×4 MIMO for DL and 2×2 MIMO for UL, but a voice call for the second subscription utilizes 2 Rx antenna ports and 1 Tx antenna port, the UE 704 may be constrained to 2×2 MIMO for DL and SISO for UL. As another example, a UE 704 may autonomously enter a power saving mode with a limited number of RF resources (e.g., 1 Rx antenna port and 1 Tx antenna port).

The UE 704 may transmit information of a number of layers that is preferred by the UE to the network (e.g., base station 702) in response to the detecting at block 750. In some implementations, the UE 704 may transmit a layer information MAC-CE 760. The layer information MAC-CE 760 may be a MAC-CE dedicated to carrying a preferred number of layers 742.

In some implementations, the UE 704 may transmit the information of a number of layers that is preferred by the UE as a field of UCI 770. For example the UCI 770 may include fields such as CQI 722, RI 724, and PMI 726. The UCI 770 may also include the preferred number of layers 742. The preferred number of layers 742 may be based on the available RF resources, which may be different than the capability indicated by UE capability message 710. Additionally, the preferred number of layers 742 may be different than the RI 724, which indicates a degree of independence between multiple antennas. Moreover, the preferred number of layers 742 may be different than a layer indicator (LI) that indicates which column of the precoder matrix of the reported PMI corresponds to the strongest layer of the codeword corresponding to the largest reported wideband CQI.

The base station 702 and the UE 704 may transmit and receive communications 790 based on the preferred number of layers 742. For example, the base station 702 may determine a number of layers 782 and transmit a DCI 780 to schedule the UE 704 to transmit or receive using the number of layers 782. In some implementations, the UE 704 may determine a number of layers based on the DMRS Configuration Type, max Length, and the number of layers 782.

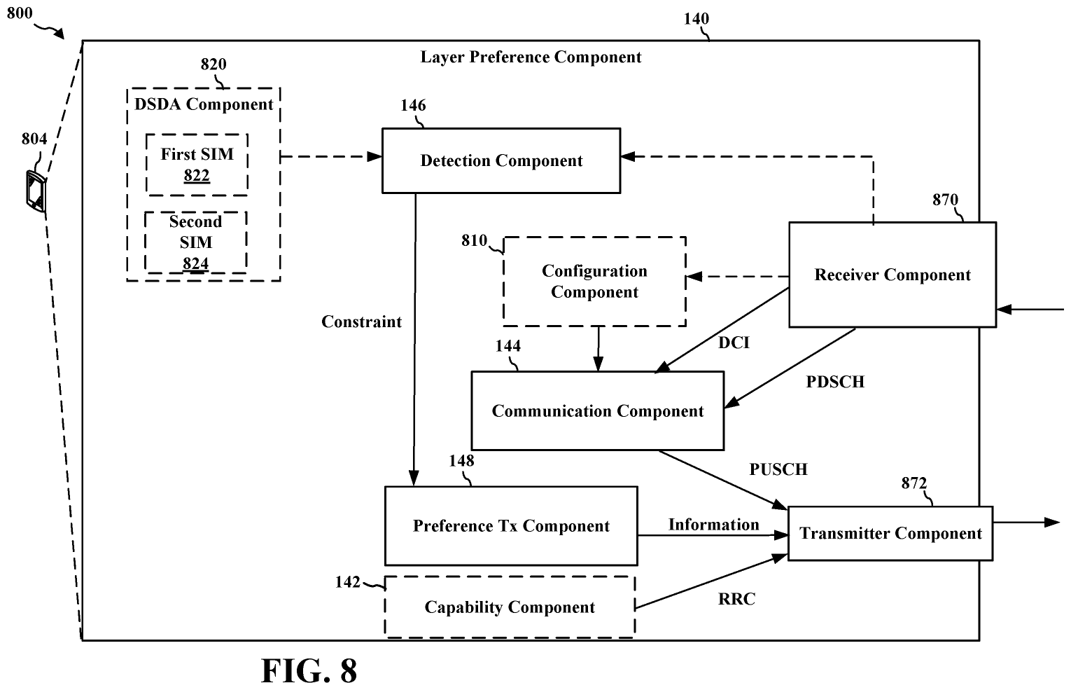

FIG. 8 is a conceptual data flow diagram 800 illustrating the data flow between different means/components in an example UE 804, which may be an example of the UE 804, or the UE 104 and include the layer preference component 140. The layer preference component 140 may be implemented by the memory 360 and the Tx processor 368, the Rx processor 356, and/or the controller/processor 359. For example, the memory 360 may store executable instructions defining the layer preference component 140 and the Tx processor 368, the Rx processor 356, and/or the controller/processor 359 may execute the instructions.

The UE 804 may include a receiver component 870, which may include, for example, a RF receiver for receiving the signals described herein. The UE 804 may include a transmitter component 872, which may include, for example, an RF transmitter for transmitting the signals described herein. In an aspect, the receiver component 870 and the transmitter component 872 may co-located in a transceiver such as the Tx/Rx 352 in FIG. 3.

As discussed with respect to FIG. 1, the layer preference component 140 may include the communication component 144, the detection component 146, the preference Tx component 148. In some implementations, the layer preference component 140 may optionally include the capability component 142 or a configuration component 810. In some implementations, the layer preference component 140 may include or communicate with a DSDA component 820 including a first SIM 822 and a second SIM 824.

The receiver component 870 may receive DL signals described herein such as the configuration 715, the DCI 730, 780, or the communications 740, 790 (e.g., a PDSCH). The receiver component 870 may provide the configuration 715 to the configuration component 810. The receiver component 870 may provide the DCI 730, 780, or the communications 740, 790 to the communication component 144.

In some implementations, the capability component 142 may transmit the capability message 710. For example, the capability message 710 may indicate a number of Tx antenna ports and/or Rx antenna ports for MIMO communications. In some implementations, the capability component 142 may indicate a capability for DSDA or a capability to transmit a layer preference message.

In some implementations, the configuration component 810 may be configured to receive a configuration 715 for MIMO communications. For example, the configuration 715 may indicate DMRS Configuration Type and max Length. The configuration component 810 may configure the communication component 144 with the parameters for MIMO communications.

The communication component 144 may communicate with the first network according to a capability indicated by the UE 804 (e.g., capability message 710) or a preferred number of layers 742 indicated by the UE 804. For example, the communication component 144 may receive a DCI 730 or 780 scheduling a PDSCH or PUSCH and indicating a number of layers 732 or 782. The communication component 144 may determine the number of layers for the PDSCH or the PUSCH based on the number of layers 732, 782 and the configuration 715. In an aspect, where the UE 804 has transmitted a layer preference message 610, the number of layers 782 may be based on the preferred number of layers 742.

The detection component 146 may be configured to detect a limitation of the RF resources. For example, the detection component 146 may receive an indication from DSDA component 820 and/or receiver component 870 that the UE 804 has received a voice call on a second network for a second subscription (e.g., for second SIM 824). The detection component 146 may identify a constraint (e.g., for the first network associated with first SIM 822) based on the detected limitation. The detection component 146 may indicate the constraint to the preference Tx component 148.

The preference Tx component 148 may receive the indication of the constraint from the detection component 146. The preference Tx component 148 may determine a preferred number of layers 742 based on the constraint. For example, the preferred number of layers may be based on a number of Tx chains or Rx chains available for the first network after the constraint. The preference Tx component 148 may generate a layer preference message 610 including information of a number of layers that is preferred by the UE. The preference Tx component 148 may transmit the layer preference message 610 to the network via the transmitter component 872 (e.g., as a layer information MAC-CE 760 or UCI 770).

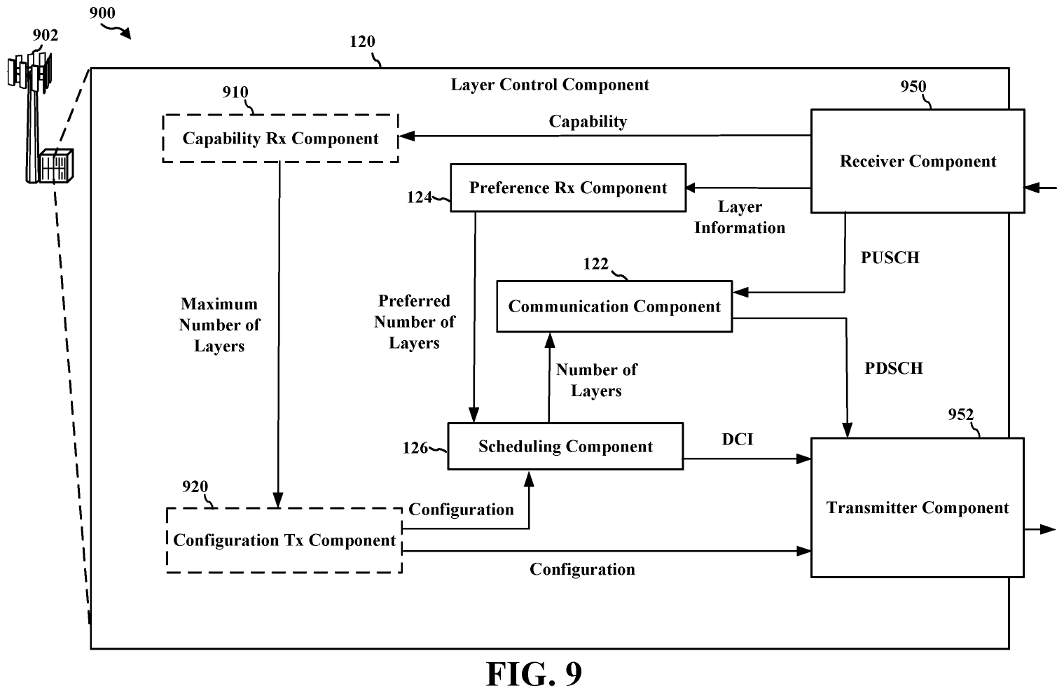

FIG. 9 is a conceptual data flow diagram 900 illustrating the data flow between different means/components in an example base station 902, which may be an example of the base station 102 including the layer control component 120. The layer control component 120 may be implemented by the memory 376 and the Tx processor 316, the Rx processor 370, and/or the controller/processor 375 of FIG. 3. For example, the memory 376 may store executable instructions defining the layer control component 120 and the Tx processor 316, the Rx processor 370, and/or the controller/processor 375 may execute the instructions.

The base station 902 may include a receiver component 950, which may include, for example, a radio frequency (RF) receiver for receiving the signals described herein. The base station 902 may include a transmitter component 952, which may include, for example, an RF transmitter for transmitting the signals described herein. In an aspect, the receiver component 950 and the transmitter component 952 may co-located in a transceiver such as illustrated by the Tx/Rx 318 in FIG. 3.

As discussed with respect to FIG. 1, the layer control component 120 may include the communication component 122, the preference Rx component 124, and the scheduling component 126. In some implementations, the layer control component 120 may optionally include a capability Rx component 910 and a configuration Tx component 920.

The receiver component 950 may receive UL signals from the UE 804 including the capability message 710, the UCI 720, 770, the communications 740, 790, or the layer information MAC-CE 760. The receiver component 950 may provide the capability message 710 to the capability Rx component 910. The receiver component 950 may provide the UCI 720, 770 and the communications 740, 790 to the communication component 122. The receiver component 950 may provide the UCI 770 including the preferred number of layers 742 or the layer information MAC-CE 760 to the preference Rx component 124.

In some implementations, the capability Rx component 910 may be configured to receive a capability message 710 from the UE. For example, the capability message 710 may indicate a maximum number of layers for the UE. The capability Rx component 910 may provide the maximum number of layers to the configuration Tx component 920.

In some implementations, the configuration Tx component 920 may be configured to transmit a configuration 715 to a UE. For example, the configuration 715 may include MIMO configuration parameters such as a DMRS Configuration Type and max Length. For instance, the MIMO configuration parameters may be based on the UE capability. The configuration Tx component 920 may also provide the configuration parameters to the scheduling component 126.

The preference Rx component 124 may be configured to receive a layer preference message 610 via the receiver component 950. For example, the preference Rx component 124 may receive the layer information MAC-CE 760 or the UCI 770 including the preferred number of layers 742. The preference Rx component 124 may provide the preferred number of layers 742 to the scheduling component 126.

The scheduling component 126 may receive the preferred number of layers from the preference Rx component 124. When no preferred number of layers is received, the scheduling component 126 may assume the number of layers is the maximum number of layers indicated by the UE capability. The scheduling component 126 mays schedule communications 740, 790 based on the maximum number of layers or the preferred number of layers as well as UCI 720, 770. In some cases, the scheduling component 126 may limit the number of layers for a PUSCH or PDSCH based on the preferred number of layers 742 indicated by the UE 804. The scheduling component 126 may transmit a DCI 730, 780 indicating the number of layers 732, 782 to the UE.

The communication component 122 may communicate with a UE based on a number of layers 732, 782 indicated by the scheduling component 126. For example, the communication component 144 may receive a PUSCH or transmit a PDSCH.

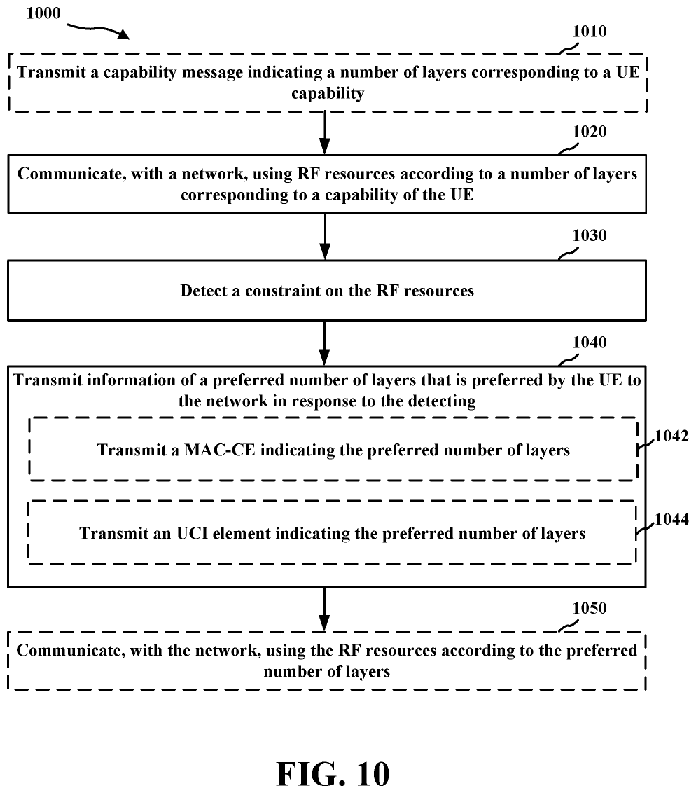

FIG. 10 is a flowchart of an example method 1000 for a UE (e.g., UE 104, UE 704, or UE 804) to indicate a preferred number of layers based on a RF resource constraint. The method 1000 may be performed by a UE 804 (such as the UE 104, which may include the memory 360 and which may be the entire UE 104 or a component of the UE 104 such as the layer preference component 140, Tx processor 368, the Rx processor 356, or the controller/processor 359). The method 1000 may be performed by the layer preference component 140 in communication with the layer control component 120 of the base station 102. Optional blocks are shown with dashed lines.

At block 1010, the method 1000 may optionally include transmitting a capability message indicating a number of layers corresponding to a UE capability. In some implementations, for example, the UE 104, the Tx processor 368 or the controller/processor 359 may execute the layer preference component 140 or the capability component 142 to transmit a capability message 710 indicating the number of layers corresponding to a UE capability. Accordingly, the UE 104, the Tx processor 368, or the controller/processor 359 executing the layer preference component 140 or the capability component 142 may provide means for transmitting a capability message indicating a number of layers corresponding to a UE capability.

At block 1020, the method 1000 includes communicating, with a network, using RF resources according to a number of layers corresponding to a capability of the UE. In some implementations, for example, the UE 104, the Tx processor 368 or the controller/processor 359 may execute the layer preference component 140 or the communication component 144 to communicate, with a network (e.g., base station 102) using RF resources 500 according to a number of layers corresponding to a capability of the UE. Accordingly, the UE 104, the Tx processor 368, or the controller/processor 359 executing the layer preference component 140 or the communication component 144 may provide means for communicating, with a network, using RF resources according to a number of layers corresponding to a capability of the UE.

At block 1030, the method 1000 may include detecting a constraint on the RF resources. In some implementations, for example, the UE 104, the Rx processor 356 or the controller/processor 359 may execute the layer preference component 140 or the detection component 146 to detect the constraint on the RF resources 500. For example, where the UE is a DSDA UE, the detection component 146 may detect the constraint on the RF resources based on activity for a second subscription while the UE is communicating with the network for a first subscription. For instance, a constraint may occur when the UE communicates with the network for the first subscription on a first band and communicates with a second network for the second subscription on the first band. In some implementations, detecting the constraint on the RF resources is based on a low power condition. Accordingly, the UE 104, the Rx processor 356, or the controller/processor 359 executing the layer preference component 140 or the detection component 146 may provide means for detecting a constraint on the RF resources.

At block 1040, the method 1000 may include transmitting information of a preferred number of layers that is preferred by the UE to the network in response to the detecting. In some implementations, for example, the UE 104, the Tx processor 368, or the controller/processor 359 may execute the layer preference component 140 or the preference Tx component 148 to transmit the information of the preferred number of layers that is preferred by the UE to the network in response to the detecting. For example, in some implementations, at sub-block 1042, the block 1040 may optionally include transmitting a MAC-CE indicating the preferred number of layers 742. As another example, in some implementations, at sub-block 1044, the block 1040 may optionally include transmitting an UCI element indicating the preferred number of layers 742. The UCI 770 may further include a rank indicator (e.g., RI 724) or layer indicator separate from the preferred number of layers 742. Accordingly, the UE 104, the Tx processor 368, or the controller/processor 359 executing the layer preference component 140 or the preference Tx component 148 may provide means for transmitting information of a preferred number of layers that is preferred by the UE to the network in response to the detecting.

At block 1050, the method 1000 may optionally include communicating, with the network, using the RF resources according to the preferred number of layers. In some implementations, for example, the UE 104, the Rx processor 356, the Tx processor 368, or the controller/processor 359 may execute the layer preference component 140 or the communication component 144 to communicate, with the network, using the RF resources according to the preferred number of layers. Accordingly, the UE 104, the Rx processor 356, the Tx processor 368, or the controller/processor 359 executing the layer preference component 140 and/or the communication component 144 may provide means for communicating, with the network, using the RF resources according to the preferred number of layers.

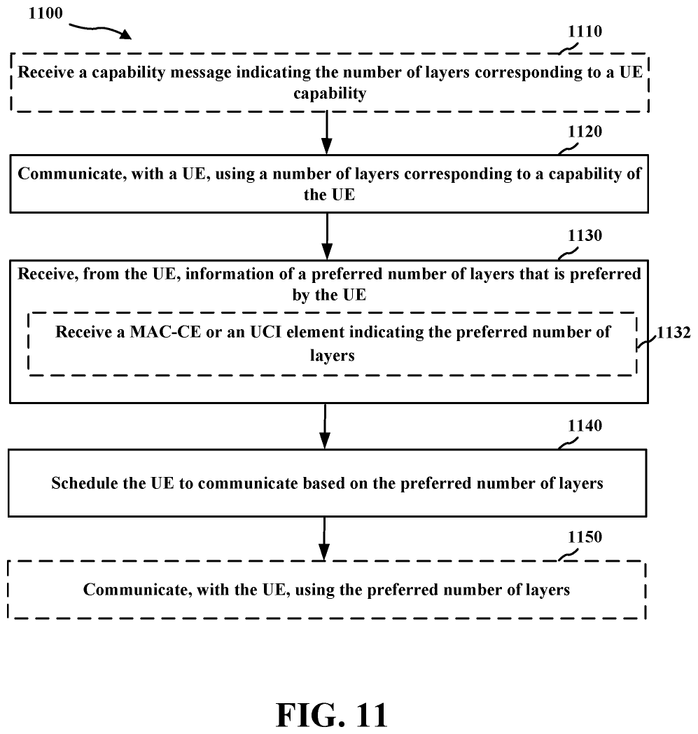

FIG. 11 is a flowchart of an example method 1100 for a base station to control a number of layers for communications with a UE based on a preference of the UE. The method 1100 may be performed by a base station (such as the base station 102, which may include the memory 376 and which may be the entire base station 102 or a component of the base station 102 such as the layer control component 120, the Tx processor 316, the Rx processor 370, or the controller/processor 375). The method 1100 may be performed by the layer control component 120 in communication with the layer preference component 140 of the UE 104.

At block 1110, the method 1100 may optionally include receiving a capability message indicating the number of layers corresponding to a UE capability. In some implementations, for example, the base station 102, the Rx processor 370, or the controller/processor 375 may execute the layer control component 120 or the capability Rx component 910 to receive a capability message 710 indicating the number of layers corresponding to a UE capability. Accordingly, the base station 102, the Tx processor 316, or the controller/processor 375 executing the layer control component 120 or the capability Rx component 910 may provide means for receiving a capability message indicating the number of layers corresponding to a UE capability.

At block 1120, the method 1100 includes communicate, with a UE, using a number of layers corresponding to a capability of the UE. In some implementations, for example, the base station 102, the Tx processor 316, the Rx processor 370, or the controller/processor 375 may execute the layer control component 120 or the communication component 122 to communicate, with a UE 104, using a number of layers corresponding to a capability of the UE. Accordingly, the base station 102, the Tx processor 316, the Rx processor 370, or the controller/processor 375 executing the layer control component 120 or the communication component 122 may provide means communicating, with a UE, using a number of layers corresponding to a capability of the UE.

At block 1130, the method 1100 includes receiving, from the UE, information of a preferred number of layers that is preferred by the UE. In some implementations, for example, base station 102, the Rx processor 370, or the controller/processor 375 may execute the layer control component 120 or the preference Rx component 124 to receive, from the UE 104, information of a preferred number of layers 742 that is preferred by the UE. For example, at sub-bock 1132, the block 1130 may optionally include receiving a MAC-CE 760 or an UCI element (e.g., of UCI 770) indicating the preferred number of layers 742. Accordingly, the base station 102, the Rx processor 370, or the controller/processor 375 executing the layer control component 120 or the preference Rx component 124 may provide means for receiving, from the UE, information of a preferred number of layers that is preferred by the UE.

At block 1140, the method 1100 includes scheduling the UE to communicate based on the preferred number of layers. In some implementations, for example, the base station 102, the Tx processor 316, or the controller/processor 375 may execute the layer control component 120 or the scheduling component 126 to schedule the UE 104 to communicate based on the preferred number of layers. Accordingly, the base station 102, the Tx processor 316, or the controller/processor 375 executing the layer control component 120 or the scheduling component 126 may provide means for scheduling the UE to communicate based on the preferred number of layers.

At block 1150, the method 1100 may optionally include communicating, with the UE, using the preferred number of layers. In some implementations, for example, base station 102, the Tx processor 316, the Rx processor 370, or the controller/processor 375 may execute the layer control component 120 or the communication component 122 to communicate, with the UE 104, using the preferred number of layers 742. Accordingly, the base station 102, the Tx processor 316, the Rx processor 370, or the controller/processor 375 executing the layer control component 120 or the communication 122 may provide means for communicating, with the UE, using the preferred number of layers.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The following numbered clauses provide an overview of aspects of the present disclosure:

1. A method of wireless communication for a user equipment (UE), comprising:
communicating, with a network, using radio frequency (RF) resources according to a number of layers corresponding to a capability of the UE;
detecting a constraint on the RF resources; and
transmitting information of a preferred number of layers that is preferred by the UE to the network in response to the detecting.

2. The method of clause 1, wherein the UE is a dual subscriber identification module (SIM) dual active (DSDA) user equipment.

3. The method of clause 2, wherein detecting the constraint on the RF resources is based on activity for a second subscription while the UE is communicating with the network for a first subscription.

4. The method of clause 3, wherein the UE communicates with the network for the first subscription on a first band and communicates with a second network for the second subscription on the first band.

5. The method of any of clauses 1-4, wherein detecting the constraint on the RF resources is based on a low power condition.

6. The method of any of clauses 1-5, wherein the RF resources are transmit chain components or receive chain components.

7. The method of any of clauses 1-6, wherein transmitting the information of the number of layers that is preferred by the UE comprises transmitting a media access control (MAC) control element (CE) indicating the preferred number of layers.

8. The method of any of clauses 1-6, wherein transmitting the information of the number of layers that is preferred by the UE comprises transmitting an uplink control information (UCI) element indicating the preferred number of layers.

9. The method of clause 8, wherein the UCI further includes a rank indicator or layer indicator separate from the number of layers that is preferred by the UE.

10. The method of any of clauses 1-9, further comprising transmitting a capability message indicating the number of layers corresponding to the UE capability.

11. An apparatus of a user equipment (UE), comprising:
a memory storing computer-executable instructions; and
at least one processor coupled to the memory and configured to execute the computer-executable instructions to perform the method of any of clauses 1-10.

12. An apparatus of a user equipment (UE), comprising means for performing the method of any of clauses 1-10.

13. A non-transitory computer-readable medium storing computer-executable instructions that when executed by a processor of a user equipment (UE), cause the UE to perform the method of any of clauses 1-10.

14. A method of wireless communication for a base station, comprising:
communicating, with a user equipment (UE), using a number of layers corresponding to a capability of the UE;
receiving, from the UE, information of a preferred number of layers that is preferred by the UE; and
scheduling the UE to communicate based on the number of layers that is preferred by the UE.

15. The method of clause 14, wherein the UE is a dual subscriber identification module (SIM) dual active (DSDA) user equipment.

16. The method of clause 14 or 15, wherein receiving the information of the number of layers that is preferred by the UE comprises receiving a media access control (MAC) control element (CE) or an uplink control information (UCI) element indicating the number of layers.

17. The method of clause 16, wherein the UCI further includes a rank indicator or layer indicator separate from the number of layers that is preferred by the UE.

18. The method of any of clauses 14-17 14, further comprising receiving a capability message indicating the number of layers corresponding to the UE capability.

19. An apparatus of wireless communication for a base station, comprising:
a memory storing computer-executable instructions; and
at least one processor coupled to the memory and configured to execute the computer-executable instructions to perform the method of any of clauses 14-18.

20. An apparatus of a base station, comprising means for performing the method of any of clauses 14-18.

21. A non-transitory computer-readable medium storing computer-executable instructions that when executed by a processor of a base station, cause the base station to perform the method of any of clauses 14-18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication for a user equipment (UE), comprising:
communicating, with a network, using radio frequency (RF) resources according to a number of layers corresponding to a capability of the UE;
detecting a constraint on the RF resources; and
transmitting information of a preferred number of layers that is preferred by the UE to the network in response to the detecting.

2. The method of claim 1, wherein the UE is a dual subscriber identification module (SIM) dual active (DSDA) user equipment.

3. The method of claim 2, wherein detecting the constraint on the RF resources is based on activity for a second subscription while the UE is communicating with the network for a first subscription.

4. The method of claim 3, wherein the UE communicates with the network for the first subscription on a first band and communicates with a second network for the second subscription on the first band.

5. The method of claim 1, wherein detecting the constraint on the RF resources is based on a low power condition.

6. The method of claim 1, wherein the RF resources are transmit chain components or receive chain components.

7. The method of claim 1, wherein transmitting the information of the number of layers that is preferred by the UE comprises transmitting a media access control (MAC) control element (CE) indicating the preferred number of layers.

8. The method of claim 1, wherein transmitting the information of the number of layers that is preferred by the UE comprises transmitting an uplink control information (UCI) element indicating the preferred number of layers.

9. The method of claim 8, wherein the UCI further includes a rank indicator or layer indicator separate from the number of layers that is preferred by the UE.

10. The method of claim 1, further comprising transmitting a capability message indicating the number of layers corresponding to the UE capability.

11. A method of wireless communication for a base station, comprising:
communicating, with a user equipment (UE), using a number of layers corresponding to a capability of the UE;
receiving, from the UE, information of a preferred number of layers that is preferred by the UE; and
scheduling the UE to communicate based on the number of layers that is preferred by the UE.

12. The method of claim 11, wherein the UE is a dual subscriber identification module (SIM) dual active (DSDA) user equipment.

13. The method of claim 11, wherein receiving the information of the number of layers that is preferred by the UE comprises receiving a media access control (MAC) control element (CE) or an uplink control information (UCI) element indicating the number of layers.

14. The method of claim 13, wherein the UCI further includes a rank indicator or layer indicator separate from the number of layers that is preferred by the UE.

15. The method of claim 11, further comprising receiving a capability message indicating the number of layers corresponding to the UE capability.

16. An apparatus of a user equipment (UE), comprising:
a memory storing computer-executable instructions; and
at least one processor coupled to the memory and configured to execute the computer-executable instructions to:
communicate, with a network, using radio frequency (RF) resources according to a number of layers corresponding to a capability of the UE;
detect a constraint on the RF resources; and
transmit information of a preferred number of layers that is preferred by the UE to the network in response to the detecting.

17. The apparatus of claim 16, wherein the UE is a dual subscriber identification module (SIM) dual active (DSDA) user equipment.

18. The apparatus of claim 17, wherein the at least one processor is configured to detect the constraint on the RF resources based on activity for a second subscription while the UE is communicating with the network for a first subscription.

19. The apparatus of claim 18, wherein the UE communicates with the network for the first subscription on a first band and communicates with a second network for the second subscription on the first band.

20. The apparatus of claim 16, wherein the at least one processor is configured to detect the constraint on the RF resources based on a low power condition.

21. The apparatus of claim 16, wherein the RF resources are transmit chain components or receive chain components.

22. The apparatus of claim 16, wherein to transmit the information of the number of layers that is preferred by the UE wherein the at least one processor is configured to transmit a media access control (MAC) control element (CE) indicating the preferred number of layers.

23. The apparatus of claim 16, wherein to transmit the information of the number of layers that is preferred by the UE, the at least one processor is configured to transmit an uplink control information (UCI) element indicating the preferred number of layers.

24. The apparatus of claim 23, wherein the UCI further includes a rank indicator or layer indicator separate from the number of layers that is preferred by the UE.

25. The apparatus of claim 16, wherein the at least one processor is configured to transmit a capability message indicating the number of layers corresponding to the UE capability.

26. An apparatus of wireless communication for a base station, comprising:
a memory storing computer-executable instructions; and
at least one processor coupled to the memory and configured to execute the computer-executable instructions to:
communicate, with a user equipment (UE), using a number of layers corresponding to a capability of the UE;
receive, from the UE, information of a preferred number of layers that is preferred by the UE; and
schedule the UE to communicate based on the number of layers that is preferred by the UE.

27. The apparatus of claim 26, wherein the UE is a dual subscriber identification module (SIM) dual active (DSDA) user equipment.

28. The apparatus of claim 26, wherein to receive the information of the number of layers that is preferred by the UE, the at least one processor is configured to receive a media access control (MAC) control element (CE) or an uplink control information (UCI) element indicating the number of layers.

29. The apparatus of claim 28, wherein the UCI further includes a rank indicator or layer indicator separate from the number of layers that is preferred by the UE.

30. The apparatus of claim 26, wherein the at least one processor is configured to receive a capability message indicating the number of layers corresponding to the UE capability.
